(19) United States
(12) Patent Application Publication
(10) Pub. No.: US 2005/0247625 A1
(43) Pub. Date: Nov. 10, 2005

(54) Determining conditions for chromatography

(76) Inventors: Jianbo Liu, Charlottesville, VA (US); Sjaan K. Armentrout, Harrisonburg, VA (US); John R. Bickler, Hampstead, NC (US); Peter C. Rahn, Palmyra, VA (US)

Correspondence Address: FISH & RICHARDSON, PC, 12390 EL CAMINO REAL, SAN DIEGO, CA, 92130-2081, US

(21) Appl. No.: 10/840,450

(22) Filed: May 5, 2004

(51) Int. Cl. B01D 15/08

(52) U.S. Cl. 210/635; 210/656; 210/198.2; 210/101; 210/96.1

(57) ABSTRACT

Systems, methods, and computer program products for determining conditions for performing chromatography. A method may be provided for separating compounds in a sample by a column chromatography system. That method includes receiving input including an indication of a retention factor that includes an indication of a first retention factor of a first component of a sample compound, and an indication of a solvent ratio; generating a gradient profile based on the received input; and separating a sample compound based on the gradient profile. In that method, the solvent ratio corresponds to the first retention factor indicated by the input and is a ratio of a first solvent and a second solvent, and the gradient profile includes a gradient portion including a starting point and an ending point corresponding to a starting ratio and an ending ratio of the first and second solvents.

### BACKGROUND

The following description relates to chromatography, and more particularly to systems and techniques for performing chromatography.

Chromatography generally involves the use of one or more solvents to separate a sample compound into multiple components as a result of the solvents and/or the sample compound flowing around, over, or through a stationary liquid or solid phase. Different mechanisms and/or techniques can be used to perform different types of chromatography. For example, thin layer chromatography (TLC) generally involves the use of a vessel containing a solvent and a chromatography plate (“the plate”). In order to perform TLC, a sample compound is added on a lower end of the plate and the plate is then rested upright, in the vessel, such that the solvent in the vessel covers the lower end of the plate. Over time, the solvent may move, via capillary action, dissolving the sample on the plate, separate the sample compound into various components, and move some of the various components up the plate at different rates. Based on differences between distances that the solvent and components of the sample move up the plate, a retention factor (Rf) can be calculated. The Rf represents the ratio of the distance traveled by a component of the sample and the solvent. For example, if a component of a sample is moved up a plate a distance A by a solvent that travels up the plate a distance B, the Rf might be the quotient of A over B.

Because each type of chromatography has different combinations of advantages and disadvantages, persons who perform chromatography may use multiple types of chromatography on a sample. However, transferring the separation conditions from one type of chromatography to another may be challenging as the separation conditions useful for one type of chromatography might not be readily transferable or assist in the performance of another type of chromatography.

Although some of the mechanisms and techniques developed thus far have provided assistance to users, such as chemists, pharmacists, and others who perform chromatography, portions of the processes of performing chromatography still require user involvement, user performed calculations, and “guess and check” work to determine conditions that might be optimal for performing chromatography.

### SUMMARY

Described herein are methods and apparatus, including computer program products, that implement mechanisms and/or techniques for performing chromatography.

In one general aspect, a method is provided for separating compounds in a sample by a column chromatography system. The method includes receiving input including an indication of a retention factor that includes an indication of a first retention factor of a first component of a sample compound, and an indication of a solvent ratio; generating a gradient profile based on the received input; and separating a sample compound based on the gradient profile. In that method, the solvent ratio corresponds to the first retention factor indicated by the input, the solvent ratio is a ratio of a first solvent and a second solvent, and the gradient profile includes a gradient portion including a starting point and an ending point corresponding to a starting ratio and an ending ratio of the first and second solvents.

Implementations may include one or more of the following features. The input may include the first retention factor and the solvent ratio. The input may further include information usable to determine a stronger solvent among the first and second solvents. The information usable to determine a stronger solvent may include an indication of the first solvent and an indication of the second solvent. In that case, the method may further include referencing a table associating solvents with solvent strength values and determining a stronger solvent among the first and second solvents based on the referenced solvent strength values. The solvent strength values may be relative solvent strength values based on polarity values. The information usable to determine a stronger solvent among the first and second solvents may include an indication of the stronger solvent.

Generating a gradient profile may include, if the first and second solvents have a solvent strength less than or equal to a solvent strength threshold, generating the gradient profile based on a first set of equations; and otherwise, generating the gradient profile based on a second set of equations. The solvent strength threshold may be about equal to a solvent strength value of 0.7. Generating the gradient profile based on the first set of equations may include generating the starting point in accordance with the equation X₁=X₀/(n*Rf), where X₁ is the starting point, X₀ is the solvent ratio, n is a variable, Rf is the first retention factor, and the starting point is expressed as a percentage of a strong solvent in a composition of the first and second solvents. “n” may be about equal to 10.0. Generating the gradient profile based on the first set of equations or the second set of equations may include generating the ending point in accordance with the equation X₂=1−Rf, where X₂ is the ending point and Rf is the first retention factor. X₂ may be the ending point, Rf may be the first retention factor, and generating the gradient profile based on the first set of equations or the second set of equations may include, if the first retention factor is equal to or above a retention factor threshold, generating the ending point in accordance with the equation X₂=1−Rf; and otherwise, generating the ending point in accordance with the equation X₂=1−(Rf)². The retention factor threshold may be about 0.1.

The second set of equations may define the starting point of the gradient profile to include a fixed percent of a solvent having a solvent strength greater than the solvent strength threshold and the method of generating the gradient profile may include determining which of the first solvent and the second solvent is the solvent having a solvent strength greater than the solvent strength threshold. The fixed percentage may be zero percentage.

The gradient profile may be a linear gradient profile or any other type of gradient profile. For example, the gradient profile may be a concave gradient profile. The method may further include, if the input indicates two or more retention factors, determining a Δ column volume based on the two more or retention factors, and determining a sample mass, a column size, and a flow rate by reference to a data repository including suggested sample masses, column sizes, and flow rates.

The input may further include an indication of a second retention factor of a second component of the sample compound and an indication of a second solvent ratio. The second solvent ratio corresponds to the second retention factor indicated by the input and may be a ratio of a third solvent and a solvent selected from the first and second solvents. The gradient profile may further include a second gradient portion including a starting point and an ending point corresponding to a starting ratio and an ending ratio of the third and selected solvents.

These techniques and features may be implemented in a chromatography system. In one general aspect, a chromatography system includes a chromatography column connected to receive a sample compound; one or more pumps connected to the chromatography column; one or more valves capable of limiting the ratio of a first solvent and a second solvent flowing to the one or more pumps; and a controller operable to perform operations, including, receiving input, generating a gradient profile based on received input, and controlling the one or more pumps and the one or more valves to separate the sample compound based on the gradient profile. In that aspect, the input includes an indication of at least one retention factor including an indication of a first retention factor of a first component of the sample compound, and an indication of a solvent ratio, such that the solvent ratio corresponds to the first retention factor indicated by the input and is a ratio of the first solvent and the second solvent. Also, in that aspect, the gradient profile includes a gradient portion including a starting point and an ending point corresponding to a starting ratio and an ending ratio of the first and second solvents.

In another aspect, a chromatography system includes a profile generator to generate a gradient profile including a gradient portion that includes a starting ratio and an ending ratio of solvents based on input; a chromatography controller including a pump controller to control one or more pumps, a valve controller to limit a ratio of two solvents flowing to the pumps, a detector controller to detect compounds flowing through a chromatography system; and a presenter to present the compounds detected by the detector to a user interface. In that aspect, input includes a first retention factor of a first component of a sample compound, and a solvent ratio corresponding to the first retention factor.

The methods and apparatus for determining conditions for chromatography described here may provide one or more of the following advantages.

A linear or non-linear gradient profile for two or more solvents may be automatically generated based on TLC data. This may advantageously allow users to transfer separation conditions automatically from TLC to column chromatography. Users might not need to perform multiple TLC runs in order to adjust TLC data for transferring separation conditions to column chromatography. As part of generating the gradient profile, a weaker or stronger solvent among the two solvents may be automatically determined based on a reference to a data repository containing information related to the solvent strength values of the two solvents (i.e., the strength of the solvents in comparison to other solvents; e.g., relative solvent strength values, such as polarity values). Thus, a user need not determine which solvent should be the start of a gradient.

The profile may be generated regardless of the presence of methanol (MeOH), or other polar solvents, in either of the two solvents. Different techniques may be used to generate the profile based on the presence of methanol or other polar solvents. Once the profile is generated, a user may edit the profile, for example, to ensure that components of a sample are completely eluted if the generated profile does not provide a sufficient duration for eluting the components of the sample.

In addition to generating the conditions for performing column chromatography included in the profile, other conditions for performing column chromatography may be generated and/or suggested. For example, a column choice, a flow rate, and a mass for a sample compound might be suggested based on various input.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a block diagram of a column chromatography system.

FIG. 2 is a block diagram of a chromatography controller of a chromatography system.

FIG. 3 is an example linear gradient profile.

FIG. 4 is a flowchart of a method of performing chromatography.

FIG. 5 is a flowchart of a method of generating a linear gradient profile.

FIGS. 6A and 6B are a flowchart of a method of generating a linear gradient profile.

### DETAILED DESCRIPTION

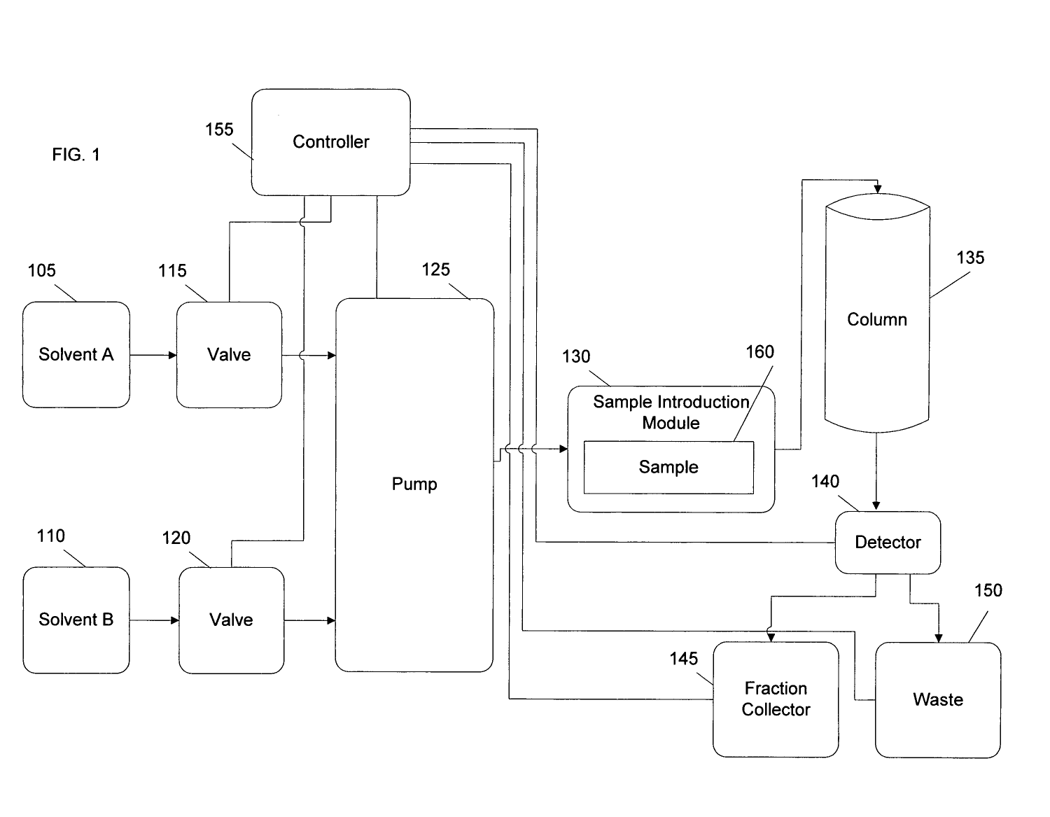

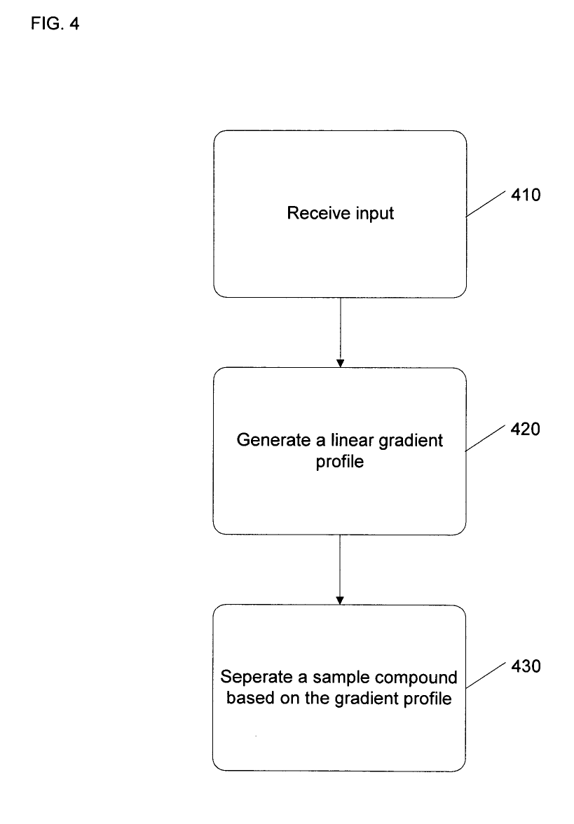

FIG. 1 is a block diagram of a column chromatography system. The chromatography system includes solvent sources 105 and 110, valves 115 and 120, a pump 125, a sample introduction module (SIM) 130, a column 135, a detector 140, a fraction collector vessel 145, a waste collector vessel 150, and a controller 155. Chromatography is performed in the system of FIG. 1 by preparing the chromatography system for use and providing input to the controller 155. Preparing the system for use may include loading a solvent A and a solvent B in the solvent sources 105 and 110, respectively, and loading a sample 160 into the SIM 130. Input provided to the controller 155 may include, for example, commands. Commands that are inputted into the controller 155 by a user may request that specific tasks be performed, such as a command requesting the pump 125 to operate at a certain flow rate for a certain period of time, or may request that more general tasks are performed, such as requesting that the system perform chromatography on a sample over a linear gradient profile, as will be discussed in greater detail in reference to FIG. 4. Other types of input may indicate certain values for which the chromatography system should perform chromatography. As examples, the input may be explicit values of conditions for performing chromatography, or, as will be discussed later, the input may be data that the controller 155 may manipulate to generate conditions for performing chromatography.

In general, the chromatography system operates by having the controller 155 cause the valves 115 and 120 to open to various degrees, thus adjusting the delivery of solvent from each of the solvent sources 105 and 110, respectively. Adjusting the delivery of solvents can affect the ratio of the solvent A in relation to the solvent B. For example, if the valve 115 is open such that twice the volume of solvent A runs through the valve 115 than the amount of solvent B that runs through the valve 120, the ratio of solvent A to solvent B might be two to one.

The solvents are pumped through the valves 115 and 120 to the SIM 130 by the pump 125. The pump 125 can deliver and stop flow of solvents, and may also control the flow rate of solvents. At the SIM 130, the solvents run around, through, or over the sample 160 that resides in the SIM 130. By running around, through, or over the sample 160, the solvents may cause components of the sample 160 to dissolve and/or to be carried with the solvents into the column 135. Although a SIM is used in the chromatography system, in alternative implementations other mechanisms and/or techniques may be used instead of, or in addition to, a SIM to introduce the sample 160 into the chromatography system. Mechanisms and/or techniques that may be used to introduce a sample into a column may include, for example, liquid injection, solid injection, use of a Samplet (i.e., a sample dispensing module, such as a Biotage AB “Samplet” module), pre-absorption of a sample, and the like.

Once at the column 135, the solvents and/or components of the sample 160 may pass from one end of the column 135 to the other end. The solvents and/or components of the sample 160 may pass through the column 135 at varying rates of time. Solvents typically pass through the column 135 at a quicker rate than components of the sample 160. For example, if solvents A and B pass through the column 135 with a component C of the sample 160, the component C may pass through the column 135, to the other end, at a slower rate. Thus, the solvent volume that exits the column 135 before components of the sample 160 is greater than the volume required to fill the column with solvent. Any type of column may be used as the column 135 and the column 135 may include any type of “stationary phase” (i.e., substance through which solvents and/or components of a sample pass). For example, the column 135 may include a liquid-liquid, liquid-solid (adsorption), size exclusion, normal-phase, reversed-phase, ion exchange, or affinity stationary phase. In alternative implementations, any number and/or combination of types of columns may be used. In addition to the column 135, the chromatography system may include any type of column such as, for example, a guard, derivatizing, capillary, fast, or preparatory column.

The detector 140 detects the various liquids and/or compounds that exit the column 135. The detector 140 may be any type of detector and may use any technique for detecting substances that exit the column 135. For example, the detector 140 may be a refractive index, ultra-violet, fluorescent, radiochemical, electrochemical, infrared, near-infrared, mass spectroscopy, nuclear magnetic resonance, or light scattering detector. The detector 140 can selectively detect liquids and/or compounds that exit the column 135, and signals interpreted by the detector 140 can be used by the controller 155 to selectively control the flow of certain liquids and/or compounds such that some substances flow into the fraction collector vessel 145 and other substances flow into the waste collector vessel 150.

The controller 155 may be any type of computer system and may control any number of aspects and/or components of the chromatography system. For example, the controller 155 may be a computer system including a data processor and user interface; the controller 155 may include only a data processor and the controller 155 may interface with another computer system for user input and/or output; or any combination of the two. As an example of a controller that interfaces with another computer system, the controller 155 may automate control of the chromatography system and the controller 155 may interface with a personal computer. In that case, a user may use the personal computer to input commands and/or program the controller 155. In addition, the personal computer may receive output from the controller 155, such as chromatography results representing the results of chromatography performed on a sample. Output from the controller 155 may be further manipulated on the personal computer and/or displayed on a display device of the personal computer.

Although FIG. 1 depicts only two solvent sources (i.e., 105 and 110), in alternative implementations any number of sources may exist and those sources may be selectively chosen by the controller 155. For example, four sources may exist, each of which is associated with a valve, and the controller 155 may chose two or more of the sources from which solvents may be pumped through the chromatography system.

In addition, other features of the chromatography system of FIG. 1 may vary. For example, the system need not include the fraction collector vessel 145 and waste collector vessel 150. As another example, the chromatography system may include more than one pump. For example, there may exist one pump for each of the solvent sources 105 and 110. As another example of a variation, any number of valves and/or pumps may exist in the chromatography system.

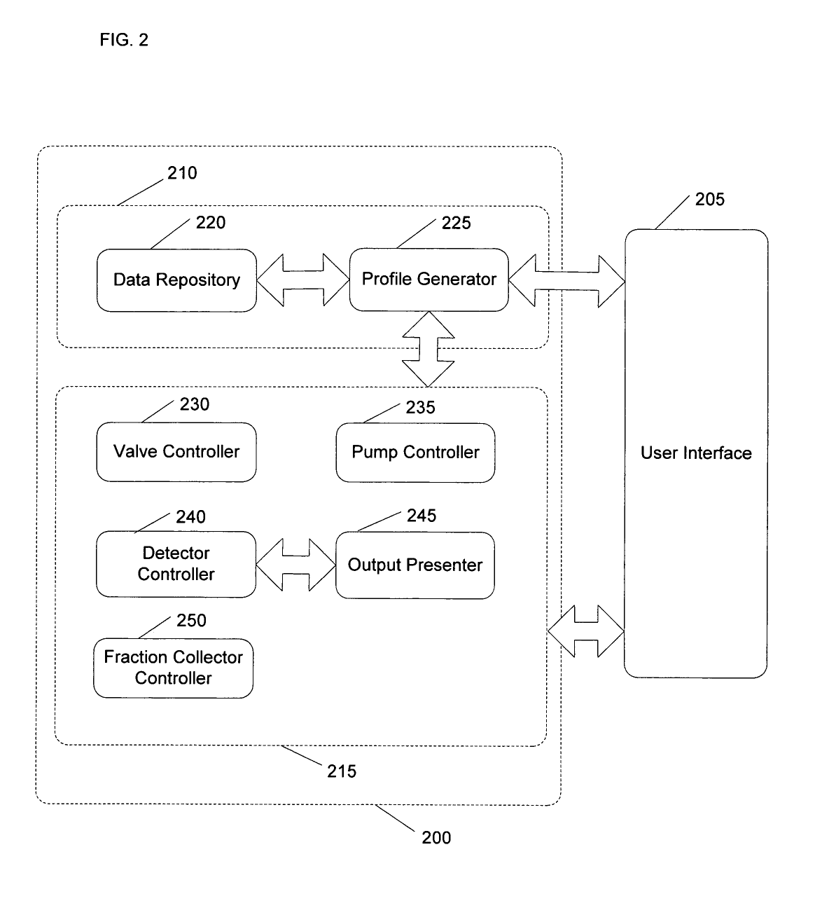

FIG. 2 is a block diagram of a chromatography controller 200 of a chromatography system. The arrows in FIG. 2 represent dataflow among the components of the chromatography controller 200 and/or between the chromatography controller 200 and the user interface 205. The chromatography controller 200 includes a profile generation system 210 and a main controller 215 that can interact with the user interface 205. The user interface 205, which may be embedded in a chromatography system or interface with a chromatography system, includes at least one input device for receiving input from a user and at least one output device for presenting output to a user. As examples, the user interface 205 may be a touch screen device or a combination of a keyboard and a display device. The user interface 205 may present any type of graphical interface, such as a graphical user interface or a command-line interface. User input may include commands and/or data for performing chromatography in a chromatography system, such as the chromatography system of FIG. 1, and input may be received at the profile generation system 210 or the main controller 215.

The profile generation system 210 generates gradient profiles that indicate conditions for performing chromatography. The profile generation system 210 includes a data repository 220 and a profile generator 225. The profile generator 225 can generate linear gradient, step, or non-linear gradient profiles that include conditions for performing chromatography in response to various combinations of input. In general, a profile generated by the profile generator 225 includes a starting point and an ending point, connected by a line, where the starting point represents a starting ratio of two solvents and the ending point represents an ending ratio of the two solvents. For example, a user may input data indicating an Rf value, a solvent ratio corresponding to the Rf value, and data indicating two solvents. In that set of input, the Rf value can be the result of performing TLC chromatography on a sample with the two solvents at the inputted solvent ratio. In response to that input, the profile generator 225 can automatically generate a linear gradient profile for use in the column chromatography system of which the controller 200 is a part. That gradient profile may indicate a starting ratio of the two solvents and an ending ratio of the two solvents. Based on the starting and ending ratios, the profile generator 225 may generate initial and final conditions that are linear steps at the same ratios as the starting and ending ratios, respectively. Additional conditions for performing chromatography in a column chromatography system may also be generated. For example, the conditions may include a column size, a sample mass, a sample load, a duration (e.g., column volume of the solvents), and the like.

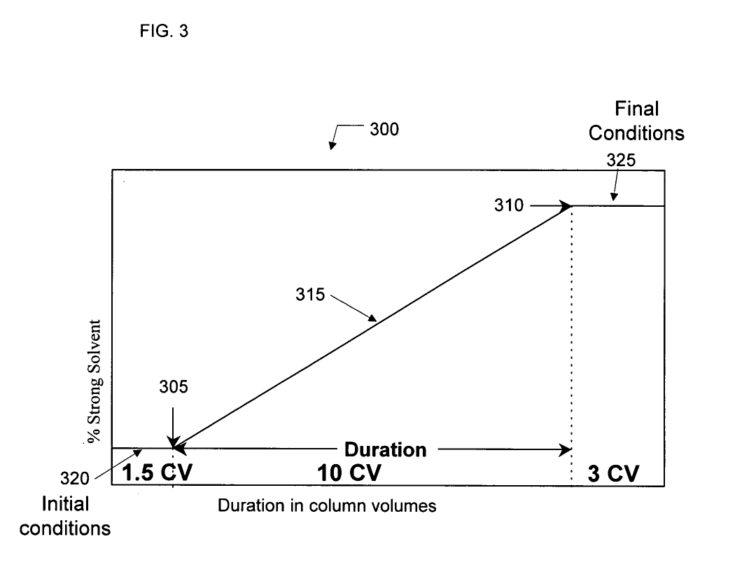

FIG. 3 is an example linear gradient profile 300. The profile of FIG. 3 may be generated by a profile generator such as the profile generator 225. The linear gradient profile 300 includes a starting point 305 and an ending point 310, connected by a substantially linear portion 315. The profile 300 indicates conditions for performing chromatography in a column chromatography system. The starting point 305 represents a starting ratio of two solvents at which a linear trend starts and the ending point 310 represents an ending ratio of the two solvents at which the linear trend ends. The horizontal axis represents duration and expresses the amount of solvent that should be pumped through a chromatography system over time. The horizontal axis of profile 300 is expressed in units of column volume (i.e., the volume of the column used in the chromatography system). The vertical axis represents the ratio of the two solvents and is expressed as a percentage of the amount of the stronger solvent over the total amount of the solvents. Thus, any point in the graph represents a solvent ratio that should be pumped in the chromatography system after a certain amount of total solvents has been pumped into a chromatography system. The profile 300 has a positive trend that indicates that the solvent ratio increases over the substantially linear portion 315 (i.e., the solvent strength increases over the substantially linear portion). Other profiles generated by the profile generator may have a negative trend indicating that the solvent ratio is decreasing, or any combination of trends indicated by any of a number of gradient portions. For example, a linear gradient profile for three solvents R, S, and T may include a first gradient portion indicating an increasing ratio of R compared to S. Then, a second gradient portion may be connected to the first gradient portion and the second gradient portion may indicate a decreasing amount of R compared to the solvent T.

In addition to the gradient portion 315, the profile 300 includes linear portions 320 and 325 (i.e., step portions). The linear portion 320 represents an amount of solvent that is pumped through the chromatography system as an initial solvent condition and may represent the starting separation conditions prior to the increase in the solvent ratio which starts at the starting point 305. The linear portion 325 represents a final solvent condition which is a volume of the solvent pumped through the system after the gradient ending point 310. The duration of each of the portions 315, 320, and 325 may be determined based on predefined amounts, calculated based on column information (e.g., the gradient portion 315 should be calculated based on the size of the column to be used), or some combination thereof. In FIG. 3 the durations of the portions 320, 315, and 325 are calculated based on a column size, hence the durations 1.5 CV (column volumes), 10 CV, and 3 CV, respectively.

As discussed, a solvent ratio may represent the amount of a stronger solvent, of the two solvents, over a total amount of the two solvents. A solvent can be relatively weaker or stronger than another solvent based on the relative solvent strength (e.g., the polarity) of the respective solvents. Referring back to FIG. 2, relative solvent strength values of the solvents may be indicated as input to the controller 200 or may be determined based on the input. For example, if two solvents are indicated as hexane and methylene chloride (MeCl₂), the profile generator 225 may determine, based on the reference of a table of polarities of various solvents, that methylene chloride is a stronger solvent. Thus, a solvent ratio based on these two solvents may represent that volume of methylene chloride over the total volume of the two solvents. For example, if there were five parts hexane in a composition with one part methylene chloride (i.e., 5:1), the ratio may be expressed as ⅙ (i.e., 1 part methylene chloride over 1 part methylene chloride and five parts hexane).

Profiles generated by the profile generator 225 need not be expressed by the same metrics or units as the example profile 300 of FIG. 3. For example, the horizontal axis may be expressed by other types of metrics, such as time (if so, time may be converted from other data using the equation: time=n*CV/F, where n is a variable that may represent a number of columns, CV is a column volume, and F is a flow rate). Also, the horizontal axis may be expressed by other units and these units may depend on the metrics that define the axis. For example, the horizontal axis may be expressed in units such as milliliters if the axis is defined in terms of volume. As another example, the vertical axis may be expressed in another form than the percentage of the strong solvent, to express a change in the solvent composition. In addition, the trend of a linear gradient profile may vary. For example, the incline may be less steep. Also, linear gradient profiles generated by the profile generator 225 may be expressed in different formats. For example, a profile may be represented as a gradient table and that table may include a starting point, an ending point, and different values corresponding to different durations within the profile. In addition, the table may include other conditions suggested for performing chromatography, such as a range of columns that are suggested for use with the profile.

The data repository 220 includes data that can be referenced for generating profiles and may be organized in one or more databases. For example, the data repository 210 may include a solvent strength database to store relative solvent strength values of elutropic series (e.g., a relative ranking of solvents ranging from non-polar to very polar), which can be referenced to determine the relative strength of solvents; a column database to store different attributes, such as volume, of columns that can be used in the chromatography system; and, a database to store suggested maximum sample sizes, indexed by Rf data and one or more column attributes (e.g., column diameter or make and model of a column, and a difference in column volumes).

The main controller 215 includes a valve controller 230, a pump controller 235, a detector controller 240, an output presenter 245, and a fraction collector controller 250, each of which can control various aspects of a chromatography system. The main controller 215 can control a chromatography system to perform chromatography in accordance with the conditions included in a linear gradient profile, such as the example linear gradient profile 300. A linear gradient profile can be supplied to the main controller 215 by the profile generator 225. In addition, the main controller 215 can operate in response to input received via the user interface 205.

The valve controller 230 controls the throughput of solvents through any number of valves in a chromatography system by controlling the degree to which valves can be opened. The pump controller 235 controls the operation of any number of pumps in a chromatography system by controlling whether the pumps are supposed to be operating and the flow rate at which the pumps should operate. Thus, the flow rate and solvent composition may be controlled by the pump controller 235 and the composition by the valve controller 220. The detector controller 240 receives data that indicates substances passing through a detector flow cell from a detector, such as the detector 140 of FIG. 1, and can send data to the output presenter 245. The output presenter 245 presents data to the user interface 205, such as, for example, data representing sensed substances in a chromatography system or other data related to performing chromatography. In addition, the output presenter may present other data, such as the status of a chromatography system. The fraction collector controller 250 receives data from the detector controller 240 and can control whether substances are directed to a fraction collector vessel or a waste collector vessel.

Although the components of the chromatography controller 200 are organized as the profile generation system 210 and the main controller 215, the components may be organized differently. For example, the components of the profile generation system need not be separate from the main system and might be a single system. Also, the chromatography controller 200 may include different and/or additional components. For example, the controller 200 may interface with a computer system that can send and receive data from the controller 200. In alternative implementations, the chromatography system may have additional and/or different data flow than is depicted in FIG. 2.

FIG. 4 is a flowchart of a method of performing chromatography. The method depicted in FIG. 4 is performed by a chromatography controller, such as the chromatography controller 200 described in reference to FIG. 2. At 410 input is received by the chromatography controller. The input includes data that can be used by the chromatography controller to calculate conditions for performing chromatography with two or more solvents over a linear gradient profile. The input may include information that would correspond to performing TLC on a sample compound using combinations of two solvents. Thus, the input may be used to adjust conditions and transfer separation conditions from TLC to column chromatography.

As an example, the input may include an indication of a retention factor (Rf) of a sample compound, an indication of a solvent ratio that produces the Rf, and an indication of two types of solvents. An indication of an Rf value may be an Rf value or one or more values that can be used to calculate an Rf value. For example, an Rf value of 0.2 may be inputted, or the Rf value may be indicated by a distance of a component of a sample compound traveling up a TLC plate and the distance a solvent traveled up the TLC plate (e.g., 2 millimeters and 10 millimeters, respectively).

Continuing with the example input, the input may indicate a solvent ratio. The solvent ratio corresponds to the TLC conditions and indicates the ratio of the two solvents that may have been used to perform TLC separation on the sample compound. The solvent ratio may be expressed in any of a number of formats, such as a percentage of a stronger solvent of two solvents. For example, if two solvents corresponding to an Rf value were a solvent A and a solvent B and the Rf value corresponded to one part solvent A and four parts solvent B, where solvent A had a stronger relative solvent strength among the two solvents, the solvent ratio may be expressed as 20% (i.e., 100×solvent A/(solvent A+solvent B)=100×(1/(1+4))).

Continuing with the example input, the input may indicate two solvents. This information can be used to determine the relative strength of the two solvents (i.e., which of the two solvents is weaker or stronger, among the two solvents). As one example, the input may indicate that a first solvent is stronger than a second solvent. As another example, the input may indicate the type of the solvents and based on that input the controller may determine which of the two solvents is stronger or weaker. This determination may be made by reference to a table of solvent strengths that may be stored in a solvent strength database. For example, in a chromatography system for normal-phase chromatography, a table may store polarity values and using the polarity values the controller may determine a strong solvent. In reversed-phase chromatography this determination may differ because the relative solvent strength may be defined differently, thus the determination of a strong solvent may differ.

In addition to input related to performing TLC on a sample compound, the input may include other information that may be useful for generating conditions for performing column chromatography over a linear gradient profile. For example, the input may indicate a column to be used in the performance of column chromatography. Column input may include the dimensions of the column or information related to a make and/or model of a column. If the make and/or model of the column is included as input, the controller may determine the dimensions (e.g., volume, diameter, and length) of the column from a database of column information. As will be discussed later, column choice information may be used to determine the duration of a gradient profile and/or the flow rate to be used when performing column chromatography.

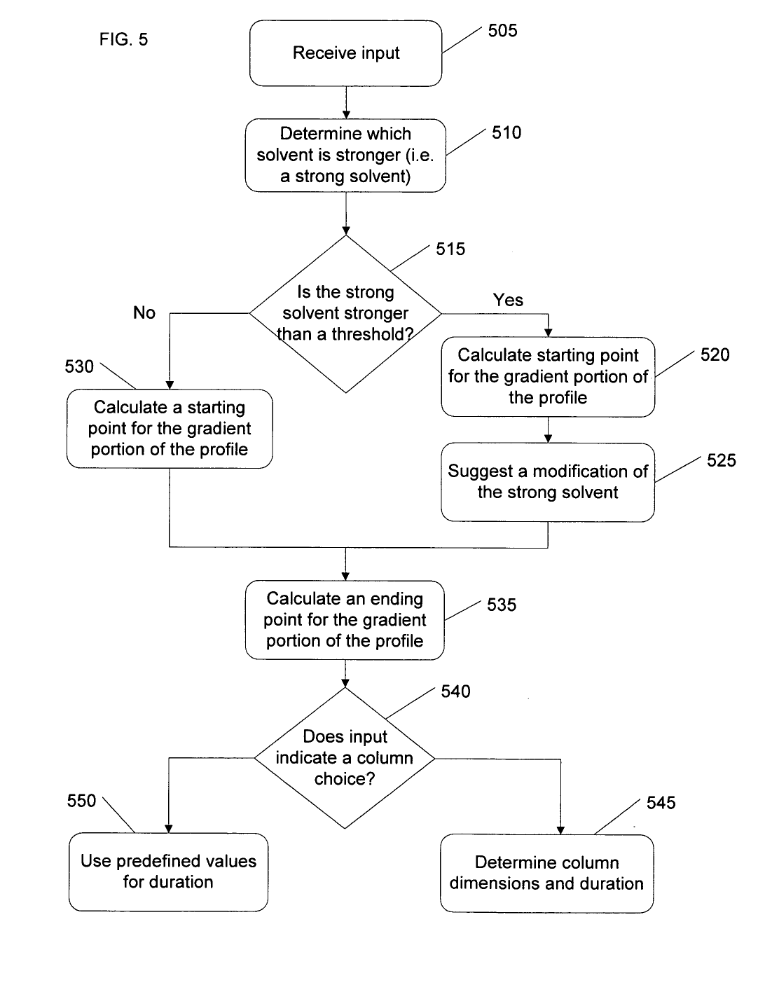

Based on the input of 410, a linear gradient profile is generated at 420. The linear gradient profile may be generated without further user input, which may facilitate an automatic transfer of separation conditions to column chromatography from the TLC data input at 410. The linear gradient profile includes the conditions for performing column chromatography over that profile. For example, the linear gradient profile may include an initial conditions portion, a gradient portion, and final conditions portion. In that profile, the initial and final conditions portions have no incline and are defined by the starting and ending points, respectively, and, the gradient portion has an incline that is defined by the starting and ending points. Each point along the profile may indicate a ratio of the solvents that should be used to perform chromatography. Any technique may be used to generate a linear gradient profile, such as the technique discussed in reference to FIG. 5 and any of a number of conditions may be generated for use in performing column chromatography.

At 430 a sample is separated using the linear gradient profile generated at 420 by performing column chromatography. The sample may be separated automatically or a user may be prompted for input before performing chromatography. For example, a linear gradient profile may be generated and based on that profile a chromatography system may start performing column chromatography without further user input. As another example, a user may be asked if they wish to modify the profile and the user may modify the profile before causing column chromatography to be performed. If a user is enabled to modify a profile, any of a number of mechanisms and/or techniques may be used to modify the profile. For example, if the controller presents the linear gradient profile as a graph in a graphical user interface, the user may use a mouse or other user input device to drag points on the graph to modify the graph. As another example, if the controller presents the linear gradient profile as a series of data values, such as starting ratio, ending ratio, and duration, the user may modify the linear gradient profile by changing these values or adding additional values to the series of data values. Changes to the linear gradient profile and other conditions for performing column chromatography can occur at any time before, during, or after a separation. For example, after a chromatographic run, a user may decide to change the linear gradient profile or other conditions to optimize the conditions for performing chromatography in a subsequent chromatographic run.

FIG. 5 is a flowchart of a method of generating a linear gradient profile. The processes of FIG. 5 are performed by a profile generator, such as the profile generator 225 of FIG. 2. At 505 input is received at the profile generator. The input includes TLC data and may include a column choice. TLC data corresponds to data related to a TLC chromatographic run on a sample compound and two solvents. The TLC data includes an Rf value, an identification of the two solvents, and a solvent ratio.

In alternative implementations, other types of data may be received as input at 505. For example, rather than receiving an Rf value, a distance that components of a sample traveled up a TLC plate and a distance that a solvent front traveled up the TLC plate may be received as input. As another example, rather than receiving the identity of the two solvents, an identification of which solvent is stronger may be received. From that information, the processes of 515-540, or similar processes, may be performed. Also as another example, more than two solvents may be received as input and that input may be combined with other input that indicates two gradients should be generated for a gradient profile. And, as another example, more than one Rf value may be received as input, where each Rf value corresponds to a component in a sample compound. The additional Rf value may be used to generate a ΔCV value from which conditions for performing chromatography may be generated, as will be discussed later.

At 510, a determination is made as to which of the two solvents is stronger (i.e., a strong solvent). This determination includes referring to a table including relative solvent strength values (i.e., the relative strength of a solvent compared to any number of solvents) for solvents and, based on two relative solvent strength values, determining that one solvent is stronger. In alternative implementations, other techniques and/or mechanisms may be used to determine which solvent is stronger, and the techniques may vary depending on the type of chromatography desired to be performed. For example, the techniques may vary depending on whether normal-phase or reversed-phase chromatography is desired to be performed.

At 515, a determination is made as to whether the strong solvent is stronger than a threshold (e.g., stronger than acetonitrile, which has a value of 0.700). This determination may include referring to the table including relative solvent strength values or using the relative solvent strength value that may have been retained from 510, and comparing the relative solvent strength value of the strong solvent to a pre-set threshold value. In alternative implementations, the determination of 515 may be based on the input that identifies the solvent at 505. For example, all solvent solutions or mixtures that include methanol may be determined to be stronger than a pre-set threshold; thus, based on the identification of a solvent provided by a user, the profile generator may determine that methanol exists in the solvent. In alternative implementations the threshold value need not be pre-set and may be modifiable by a user. As an example, a user may be asked to input a threshold relative solvent strength value.

Thus, based on the determination of 515, either a first set of processes are used to generate part of the linear gradient profile (520 and 525) or a second set of processes are used to generate part of the linear gradient profile (530). Either of these sets of processes may use one or more equations to generate a linear gradient profile.

If the strong solvent was stronger than a threshold (e.g., stronger than acetonitrile), a starting point of a gradient portion and initial conditions of the linear gradient profile are defined, at 520. The starting point may be defined as a fixed percentage or some other number based on the Rf value that was received as input. For example, the starting point may be defined as 0% of the strong solvent (i.e., the solvent composition is composed of 100% of the weaker solvent).

At 525 a suggested modification of the strong solvent is provided. The modification defines that a certain amount of a substance should be added or removed from the strong solvent for performing column chromatography. The amount by which the strong solvent should be modified may be a predefined value. For example, in one implementation, a predefined suggestion might be that 3% more methanol (MeOH) should be added to the stronger solvent. According to that implementation, if the strong solvent is composed of a ratio of 99 parts MeCl₂ and one part MeOH, the suggested modification might be that the solvent should contain 96 parts MeCl₂ and four parts MeOH. The amount by which the strong solvent should be modified may have a ceiling. For example, the profile generator may be defined to generate a suggested modification of the strong solvent such that the modified strong solvent has 3% more MeOH, but no more than 10% MeOH. In some implementations, the chromatography system may automatically adjust the amount of MeOH, or some other solvent. For example, if the strong solvent should be modified by a suggested amount as discussed above, the chromatography system may automatically adjust the composition of the strong solvent to facilitate column chromatography.

Referring back to 515, if the strong solvent has a relative solvent strength that is less than or equal to the threshold (e.g., the relative solvent strength of acetonitrile), a starting point of the gradient portion of the linear gradient profile is defined, at 530. The gradient starting point is calculated in accordance with the equation: starting point=TLC ratio/(10×Rf), where the TLC ratio is the solvent ratio expressed as a percentage as obtained as input at 505. For example, if the TLC ratio was 20% and the Rf was 0.2, the starting point would be 10% (i.e., 10% of the stronger solvent should be in the composition that is used to elute a sample at the start of a gradient). Although the equation multiplies the Rf value by a factor of 10, in alternative implementations the factor may vary and, for example, the equation for the starting point may be calculated in accordance with the equation: starting point=TLC ratio/(n×Rf), where n is a variable that may be pre-set or input by a user.

An ending point for the gradient portion of the linear gradient profile is generated at 535. The ending point is a ratio of the strong solvent and is generated in accordance with the equation: ending point=100×(1−Rf), where Rf is the retention factor obtained as input and the result is expressed as a percentage of the strong solvent in a composition of the two solvents. For example, if the Rf factor were 0.2, the ending point would be 80%. In alternative implementations, the equation used to calculate the ending point might differ depending on the Rf value. For example, the equation already described may be used if the Rf value is greater than or equal to 0.1; however, if the Rf value is less than 0.1, the ending point may be calculated based on another equation, such as ending ratio=100×(1−(Rf)²). In such an implementation, the profile generator is able to compensate for a low Rf and a user of a chromatography system need not optimize an Rf factor when performing TLC in order to transfer separation conditions to column chromatography.

At 540 the profile generator determines whether the input included a column choice (i.e., a selection of a column that will be used to perform column chromatography using the linear gradient profile). If the input included a column choice, the column dimensions are determined based on an access of a database including column data and the duration of portions of the linear gradient profile are generated based on the dimensions of the column (545). If a column choice was not entered, predefined values or variables may be used to define the duration of portions of the linear gradient profile (550). If variables are used to define the duration of portions of the linear gradient profile, values may be automatically assigned to those variables at a later time. For example, 10 column volumes may be defined as the duration of the gradient portion of the linear gradient profile. At a later time, when column chromatography is going to be performed, the column choice may be entered and the duration in terms of the actual volume of solvents that should be used may be calculated based on the dimensions of the chosen column.

In addition to the conditions indicated by the profile, as described above, other conditions may be generated by a chromatography system. For example, in one implementation, a chromatography system may generate a flow rate based on column dimensions and TLC Rf data. The system may generate these conditions by referencing a database of suggested flow rates indexed by one or more column attributes (e.g., length and/or diameter) and a ΔCV value (i.e., a difference of two column volume values which can be calculated from two Rf values, as described later). As another example, a sample mass for performing column chromatography may be suggested. The chromatography system may generate a suggested sample mass based on two or more Rf values and column attributes. The suggested sample mass may be generated by referencing a table of suggested sample masses indexed by column attributes and a ΔCV value (i.e., calculable from the two or more Rf values). As another example, a column choice may be suggested based on a sample mass and two or more Rf values, by referencing a database of suggested column choices indexed by sample masses and a ΔCV value. In that example, the flow rate for performing chromatography and suggested starting and ending solvent ratios may change based on the attributes of a column chosen. To provide the additional conditions for performing column chromatography, the method may vary. For example, in order to provide the conditions as described above, at least two Rf values may be required because two Rf values may be used to calculate a ΔCV value.

Although the examples discuss the use of a ΔCV value as a value that can be used to index suggested conditions for performing chromatography, other types of data can be used to index the suggested conditions. ΔCV represents a resolution value and may be easily adapted for any size column chosen for performing chromatography. The relationship between CV and Rf may be expressed as CV=1/Rf; thus, two or more Rf values can be used to calculate a ΔCV value by taking the inverse of two Rf values and determining the difference of those CV values (i.e., ΔCV=CV₂−CV₁ or ΔCV=(1/Rf₂)−(1/Rf₁)). For example, for two Rf values 0.20 and 0.25, the corresponding CV values are 5.0 and 4.0, respectively, and a ΔCV value would be 1.0. The ΔCV value may be advantageous as the ΔCV may be a more reliable indicator for suggesting conditions for performing chromatography.

Although the processes of FIGS. 4 and 5 were described as being performed by a controller and a profile generator of a chromatography system, respectively, the processes may be performed by any of a number of components in a chromatography system and/or with components outside a chromatography system. For example, the processes included in 410 and 420 may be performed by a computer system that interfaces with a chromatography system and that chromatography system may perform the processes included in 430.

Also, although FIGS. 4 and 5 were described in relation to only two solvents, the same techniques described in reference to FIGS. 4 and 5 may be used for more than two solvents. For example, three solvents F, G, and E may be indicated as input to a chromatography system and a user may indicate that they wish to have chromatography conditions generated that include a gradient profile with two gradient portions; a first gradient portion corresponding to solvents F and G, and a second gradient portion corresponding to solvents F and E. In that scenario, a gradient profile may be generated including the two gradients with the first gradient portion increasing the ratio of solvent F compared to solvent G and the second gradient portion increasing the ratio of solvent E compared to solvent F. In order to generate the gradient portions, the similar techniques as those described in FIGS. 4 and 5 may be used. For example, for each combination of two solvents that are relevant to the trend of increasing and/or decreasing solvent composition, an Rf value may be used to define the gradient portion corresponding to those two solvents.

Although FIGS. 4 and 5 discuss the generation of a linear gradient profile, other types of gradient profiles may be generated instead of, or in addition to, a linear gradient profile. Other types of profiles may include, for example, a concave gradient portion or a convex gradient portion. Starting and ending points for these types of gradient portions may generated using the same starting and ending points that would be generated in accordance with the techniques discussed in reference to FIG. 5. In order to generate the gradient portion of the profile (i.e., the portion between the starting and ending point) any type of function may be used. For example, linear gradient profiles are generally generated by using the equation Y=mX+b, where Y is the value of a point on the Y-axis, m is the slope, X is the value of the point on the X-axis, and b is a Y-intercept. However, a concave gradient profile may be generated in accordance with equations such as Y=X², Y=X³, and the like; and a convex gradient profile may be generated in accordance with equations such as Y=1/X, Y=1/(X²), and the like.

Although FIG. 5 describes specific equations and techniques for generating a gradient profile, the equations and techniques may vary. For example, instead of generating a percentage of a strong solvent, the equations and techniques may be modified to express the starting and ending points as a ratio in a form other than a percentage of a strong solvent, such as in the form N parts solvent A to M parts solvent B.

Although the method of FIGS. 4 and 5 are shown as being composed of a certain number and type of processes, additional and/or different processes can be used instead. Similarly, the processes need not be performed in the order depicted. For example, in FIG. 5, the processes of 525 may be performed before the processes of 520.

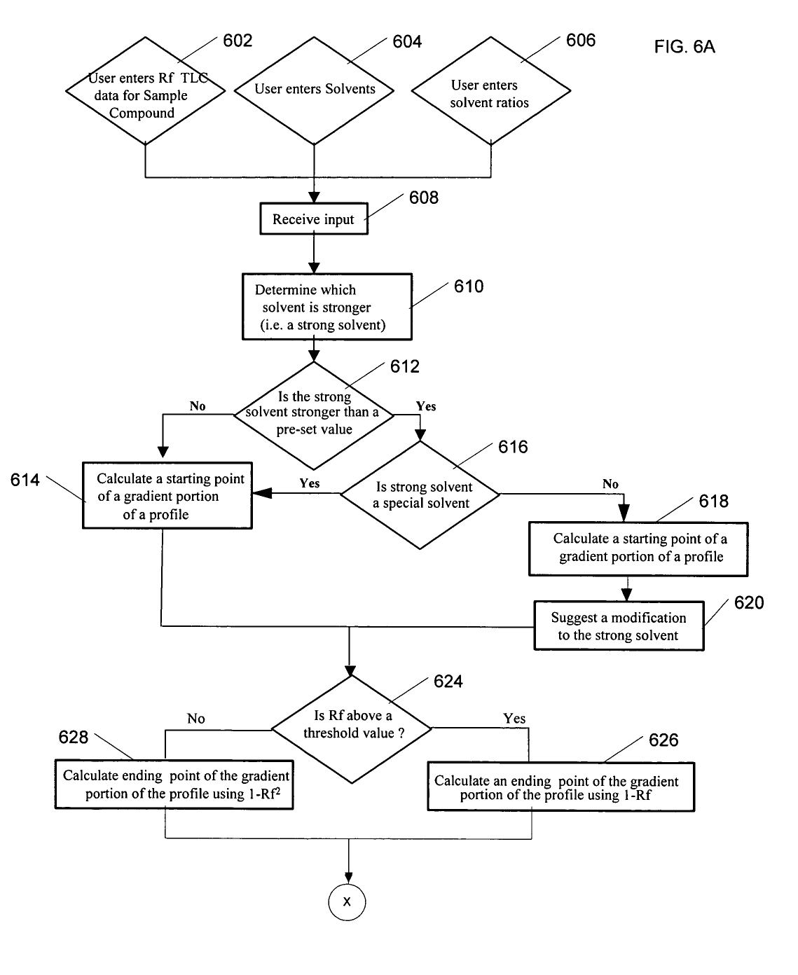

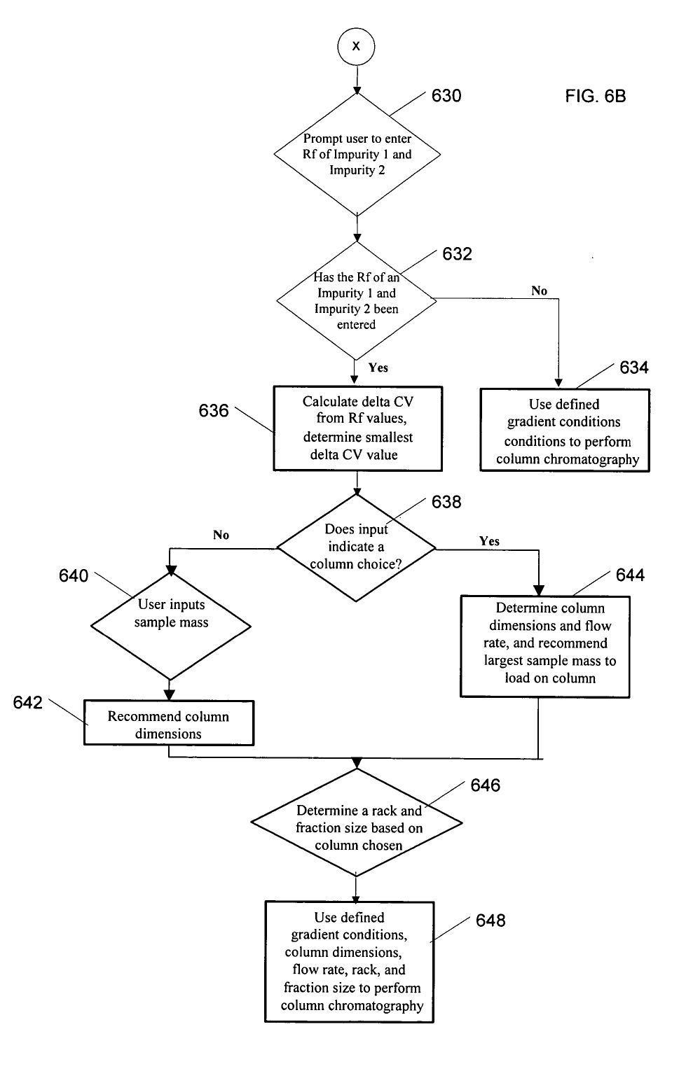

FIGS. 6A and 6B are a flowchart of a method of generating a linear gradient profile. The method implemented in FIGS. 6A and 6B may be a variation of the method illustrated in the flowchart of FIG. 5. Various input can be entered by a user at 602, 604, and 606 and/or received at 608. At 602, a user enters TLC Rf data, which includes an Rf value or data that can be used to calculate an Rf value. At 604, a user enters solvents using either the name of the solvents or the type of solvents. At 606, a user enters solvent ratios that may be expressed as a percent of a strong solvent, or may be expressed as a ratio of one solvent to another solvent.

At 610, a determination is made as to which one of two solvents is stronger. At 612, a determination is made as to whether the strong solvent is stronger than a pre-set value. For example, the determination may involve comparing a relative solvent strength value of the strong solvent, which may be determined by reference to a table associating relative solvent strength values of solvents with solvent types and/or names, with a pre-set value of 0.700. If the relative solvent strength value is above that value, then it may be determined that the process should continue at 616; otherwise, the process continues at 614. Alternatively, the determination may be made by reference to a list of solvents above and/or below a threshold. As an example, the list may indicate that methanol, ethanol, and isopropanol are above the threshold, but not acetonitrile.

At 616, a determination is made as to whether the strong solvent is a special solvent. A special solvent may be a solvent that has been determined to work preferably with one set of equations over another. The determination as to whether a solvent is a special solvent may be determined based on the input provided by a user. For example, the type of solvent identified by a user may be compared against a list of special solvents, such as, for example, a list including acetonitrile. If the strong solvent is a special solvent, the process continues at 614, otherwise the process continues at 618. At 618 a starting point of a gradient portion of a gradient profile is calculated. The starting point is a ratio and may be expressed as a percentage of the strong solvent within a composition of the strong solvent and another solvent. The calculation performed at 618 differs from the calculation performed at 614, and may be based on the Rf data. At 620, a modification to the strong solvent is suggested (i.e., a change to composition of the solvent).

At 624 through 628, an ending point for the gradient portion of the profile is calculated. At 624, a determination is made as to whether the Rf value (i.e., the Rf value that can be determined from the input at 602) is above a threshold value. The threshold value can be any value, such as 0.1. Depending on the determination at 624, either a first or second technique is used to calculate the ending point. Each technique utilizes different sets of equations. At 626, if the Rf value is at or above a threshold value, the ending point, expressed as a percentage, is calculated in accordance with the equation: ending point=100×(1−Rf). At 628, if the Rf value is below the threshold value, the ending point, expressed as a percentage, is calculated in accordance with the equation: ending point=100×(1−Rf²). For example, if the Rf value were 0.35, then the ending point would be 65% (i.e., the ending point is 65% of the strong solvent, which is 100×(1−0.35)). However, if the Rf value were 0.09, the ending point would be 99.19% (i.e., the ending point is 99.19% of the strong solvent, which is 100×(1−(0.09)²)). In alternative implementations the same technique may be used to calculate the ending point, regardless of a threshold value compared to the Rf value. The starting and ending points represent a starting and ending point of a gradient portion of a gradient profile and may also be used to define initial and final conditions, which may be step portions of the gradient profile (as discussed in reference to FIG. 3).

At 630, a user is prompted to enter an Rf value of a first and a second impurity. In other words, a user can enter an Rf value of two impurities (i.e., components) of a sample compound on which TLC was performed. At 632, if a user did enter two Rf values, the two Rf values are used at 636 to calculate a ΔCV value. In alternative implementations, if more than two Rf values were inputted, multiple ΔCV values can be calculated, and a minimum ΔCV value can then be determined from a group of ΔCV values. The minimum ΔCV value may be used as the ΔCV value used to suggest conditions for performing chromatography, which will be discussed later. If a user did not enter Rf values of a first and second impurity, column chromatography is performed, at 634, using the defined gradient conditions to perform chromatography.

At 638, a determination is made as to whether a user has indicated a column choice (e.g., a make and/or a model). If a user has indicated a column choice, column dimensions, a flow rate, and a recommended maximum sample mass to load on a column are determined at 644. This determination is made by referencing a data repository that stores column dimensions by make and model; suggested flow rates by column dimensions and ΔCV values; and recommended maximum sample masses by column dimensions and ΔCV values. If a column choice was not indicated, a user can input a sample mass at 640 and in response to that sample mass column dimensions may be recommended to the user at 642. In alternative implementations, instead of recommending column dimensions, other types of column data may be recommended to a user. For example, a list of makes and models of columns may be recommended to a user. At 646, a rack (i.e., a rack for holding sample introduction modules) and fraction size can be suggested based on a column that is chosen by a user. At 648, all of the conditions, including the initial and final gradient conditions, column dimensions, flow rate, suggested rack, and fraction size can be used to perform column chromatography.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices) used to provide machine instructions and/or data to a programmable processor, including a machine-readable medium that receives machine instructions as a machine-readable signal. The term “machine-readable signal” refers to any signal used to provide machine instructions and/or data to a programmable processor.

Thus, although a few implementations have been described in detail above, other modifications are possible. Other implementations may be within the scope of the following claims.

1. A method of separating compounds in a sample by a column chromatography system, the method comprising:
receiving input comprising:
an indication of at least one retention factor comprising an indication of a first retention factor of a first component of a sample compound, and
an indication of a solvent ratio, the solvent ratio corresponding to the first retention factor indicated by the input and being a ratio of a first solvent and a second solvent,
generating a gradient profile based on the received input, the gradient profile comprising a gradient portion comprising a starting point and an ending point corresponding to a starting ratio and an ending ratio of the first and second solvents; and
separating a sample compound based on the gradient profile.

2. The method of claim 1, wherein the input comprises the first retention factor and the solvent ratio.

3. The method of claim 1, wherein the input further comprises information usable to determine a stronger solvent among the first and second solvents.

4. The method of claim 3, wherein the information usable to determine a stronger solvent comprises an indication of the first solvent and an indication of the second solvent, the method further comprising:
referencing a table associating solvents with solvent strength values; and
determining a stronger solvent among the first and second solvents based on the referenced solvent strength values.

5. The method of claim 3, wherein the solvent strength values are relative solvent strength values based on polarity values.

6. The method of claim 3, wherein the information usable to determine a stronger solvent among the first and second solvents comprises an indication of the stronger solvent.

7. The method of claim 1, wherein generating a gradient profile comprises:
if the first and second solvents have a solvent strength less than or equal to a solvent strength threshold, generating the gradient profile based on a first set of equations; otherwise, generating the gradient profile based on a second set of equations.

8. The method of claim 7, wherein the solvent strength threshold is about equal to a solvent strength value of 0.7.

9. The method of claim 7, wherein generating the gradient profile based on the first set of equations comprises generating the starting point in accordance with the equation X₁=X₀/(n*Rf), where X₁ is the starting point, X₀ is the solvent ratio, n is a variable, Rf is the first retention factor, and the starting point is expressed as a percentage of a strong solvent in a composition of the first and second solvents.

10. The method of claim 9, wherein n is about equal to 10.0.

11. The method of claim 7, wherein generating the gradient profile based on the first set of equations or the second set of equations comprises generating the ending point in accordance with the equation X₂=1−Rf, where X₂ is the ending point and Rf is the first retention factor.

12. The method of claim 7, wherein X₂ is the ending point, Rf is the first retention factor, and generating the gradient profile based on the first set of equations or the second set of equations comprises:
if the first retention factor is equal to or above a retention factor threshold, generating the ending point in accordance with the equation X₂=1−Rf, otherwise generating the ending point in accordance with the equation X₂=1−(Rf)².

13. The method of claim 12, wherein the retention factor threshold is about 0.1.

14. The method of claim 7, wherein the second set of equations defines the starting point of the gradient profile to comprise a fixed percent of a solvent having a solvent strength greater than the solvent strength threshold and the method of generating the gradient profile comprises:
determining which of the first solvent and the second solvent is the solvent having a solvent strength greater than the solvent strength threshold.

15. The method of claim 13, wherein the fixed percentage is zero percentage.

16. The method of claim 1, wherein the gradient profile is a linear gradient profile.

17. The method of claim 1 further comprising:
if the input indicates two or more retention factors,
determining a Δ column volume based on the two more or retention factors; and
determining a sample mass, a column size, and a flow rate by reference to a data
repository comprising suggested sample masses, column sizes, and flow rates.

18. The method of claim 1, wherein:
the input further comprises:
an indication of a second retention factor of a second component of the sample compound, and
an indication of a second solvent ratio, the second solvent ratio corresponding to
the second retention factor indicated by the input and being a ratio of a third solvent and a solvent selected from the first and second solvents; and
the gradient profile further comprises a second gradient portion comprising a starting point and an ending point corresponding to a starting ratio and an ending ratio of the third and selected solvents.

19. A chromatography system comprising:
a chromatography column connected to receive a sample compound;
one or more pumps connected to the column;
one or more valves capable of limiting the ratio of a first solvent and a second solvent flowing to the one or more pumps; and
a controller operable to perform operations comprising:
receiving input comprising:
an indication of at least one retention factor comprising an indication of a first retention factor of a first component of the sample compound, and
an indication of a solvent ratio, the solvent ratio corresponding to the first retention factor indicated by the input and being a ratio of the first solvent and the second solvent,
generating a gradient profile based on received input, the gradient profile comprising a gradient portion comprising a starting point and an ending point corresponding to a starting ratio and an ending ratio of the first and second solvents; and
controlling the one or more pumps and the one or more valves to separate the sample compound based on the gradient profile.

20. The chromatography system of claim 19, wherein the input comprises the first retention factor and the solvent ratio.

21. The chromatography system of claim 19, wherein the input further comprises information usable to determine a stronger solvent among the first and second solvents.

22. The chromatography system of claim 21, wherein the information usable to determine a stronger solvent comprises an indication of the first solvent and an indication of the second solvent, the controller further operable to perform operations comprising:
referencing a table associating solvents with solvent strength values; and
determining a stronger solvent among the first and second solvents based on the referenced solvent strength values.

23. The chromatography system of claim 21, wherein the information usable to determine a stronger solvent among the first and second solvents comprises an indication of the stronger solvent.

24. The chromatography system of claim 19, wherein generating a gradient profile comprises:
if the first and second solvents have a solvent strength less than or equal to a solvent strength threshold, generating the gradient profile based on a first set of equations; otherwise, generating the gradient profile based on a second set of equations.

25. The chromatography system of claim 24, wherein the solvent strength threshold is about equal to a solvent strength value of 0.7.

26. The chromatography system of claim 24, wherein generating the gradient profile based on the first set of equations comprises generating the starting point in accordance with the equation X₁=X₀/(n*Rf), where X₁ is the starting point, X₀ is the solvent ratio, n is a variable, Rf is the first retention factor, and the starting point is expressed as a percentage of a strong solvent in a composition of the first and second solvents.

27. The chromatography system of claim 26, wherein n is about equal to 10.0.

28. The chromatography system of claim 24, wherein generating the gradient profile based on the first set of equations or the second set of equations comprises generating the ending point in accordance with the equation X₂=1−Rf, where X₂ is the ending point and Rf is the first retention factor.

29. The chromatography system of claim 24, wherein X₂ is the ending point, Rf is the first retention factor, and generating the gradient profile based on the first set of equations or the second set of equations comprises:
if the first retention factor is equal to or above a retention factor threshold, generating the ending point in accordance with the equation X₂=1−Rf; otherwise generating the ending point in accordance with the equation X₂=1−(Rf)².

30. The chromatography system of claim 29, wherein the retention factor threshold is about 0.1.

31. The chromatography system of claim 24, wherein the second set of equations defines the starting point of the gradient profile to comprise a fixed percent of a solvent having a solvent strength greater than the solvent strength threshold and the method of generating the gradient profile comprises:
determining which of the first solvent and the second solvent is the solvent having a solvent strength greater than the solvent strength threshold.

32. The chromatography system of claim 31, wherein the fixed percentage is zero percentage.

33. The chromatography system of claim 19, wherein the gradient profile is a linear gradient profile.

34. The chromatography system of claim 19, wherein the controller is further operable to perform operations comprising:
if the input indicates two or more retention factors,
determining a Δ column volume based on the two more or retention factors; and
determining a sample mass, a column size, and a flow rate by reference to a data
repository comprising suggested sample masses, column sizes, and flow rates.

35. The chromatography system of claim 19, wherein:
the input further comprises:
an indication of a second retention factor of a second component of the sample compound, and
an indication of a second solvent ratio, the second solvent ratio corresponding to
the second retention factor indicated by the input and being a ratio of a third solvent and a solvent selected from the first and second solvents; and
the gradient profile further comprises a second gradient portion comprising a starting point and an ending point corresponding to a starting ratio and an ending ratio of the third and selected solvents.

36. A chromatography system comprising:
a profile generator to generate a gradient profile comprising a gradient portion comprising a starting ratio and an ending ratio of solvents based on input comprising:
a first retention factor of a first component of a sample compound, and
a solvent ratio corresponding to the first retention factor; and
a chromatography controller comprising:
a pump controller to control one or more pumps;
a valve controller to limit a ratio of two solvents flowing to the one or more pumps; and
a detector controller to detect compounds flowing through a chromatography system; and
a presenter to present the compounds detected by the detector to a user interface.

37. The chromatography system of claim 36, wherein the input comprises the first retention factor and the solvent ratio.

38. The chromatography system of claim 36, wherein the input further comprises information usable to determine a stronger solvent among the first and second solvents.

39. The chromatography system of claim 38, wherein the information usable to determine a stronger solvent comprises an indication of the first solvent and an indication of the second solvent, the profile generator to further:
reference a table associating solvents with solvent strength values; and
determine a stronger solvent among the first and second solvents based on the referenced solvent strength values.

40. The chromatography system of claim 38, wherein the information usable to determine a stronger solvent among the first and second solvents comprises an indication of the stronger solvent.

41. The chromatography system of claim 36, wherein generating a gradient profile comprises:
if the first and second solvents have a solvent strength less than or equal to a solvent strength threshold, generating the gradient profile based on a first set of equations; otherwise, generating the gradient profile based on a second set of equations.

42. The chromatography system of claim 41, wherein the solvent strength threshold is about equal to a solvent strength value of 0.7.

43. The chromatography system of claim 41, wherein generating the gradient profile based on the first set of equations comprises generating the starting point in accordance with the equation X₁=X₀/(n*Rf), where X₁ is the starting point, X₀ is the solvent ratio, n is a variable, Rf is the first retention factor, and the starting point is expressed as a percentage of a strong solvent in a composition of the first and second solvents.

44. The chromatography system of claim 43, wherein n is about equal to 10.0.

45. The chromatography system of claim 41, wherein generating the gradient profile based on the first set of equations or the second set of equations comprises generating the ending point in accordance with the equation X₂=1−Rf, where X₂ is the ending point and Rf is the first retention factor.

46. The chromatography system of claim 41, wherein X₂ is the ending point, Rf is the first retention factor, and generating the gradient profile based on the first set of equations or the second set of equations comprises:
if the first retention factor is equal to or above a retention factor threshold, generating the ending point in accordance with the equation X₂=1−Rf; otherwise generating the ending point in accordance with the equation X₂=1−(Rf)².

47. The chromatography system of claim 46, wherein the retention factor threshold is about 0.1.

48. The chromatography system of claim 41, wherein the second set of equations defines the starting point of the gradient profile to comprise a fixed percent of a solvent having a solvent strength greater than the solvent strength threshold and the method of generating the gradient profile comprises:
determining which of the first solvent and the second solvent is the solvent having a solvent strength greater than the solvent strength threshold.

49. The chromatography system of claim 48, wherein the fixed percentage is zero percentage.

50. The chromatography system of claim 36, wherein the gradient profile is a linear gradient profile.

51. The chromatography system of claim 36, wherein if the input indicates two or more retention factors, the profile generator to:
determine a Δ column volume based on the two more or retention factors; and
determine a sample mass, a column size, and a flow rate by reference to a data repository comprising suggested sample masses, column sizes, and flow rates.

52. The chromatography system of claim 36, wherein:
the input further comprises:
an indication of a second retention factor of a second component of the sample compound, and
an indication of a second solvent ratio, the second solvent ratio corresponding to
the second retention factor indicated by the input and being a ratio of a third solvent
and a solvent selected from the first and second solvents; and
the gradient profile further comprises a second gradient portion comprising a starting point and an ending point corresponding to a starting ratio and an ending ratio of the third and selected solvents.
